(19) United States
(12) Patent Application Publication
(10) Pub. No.: US 2005/0240499 A1
(43) Pub. Date: Oct. 27, 2005

(54) Drawing system and drawing method

(76) Inventors: Kensuke Morita, Munakata-shi (JP); Naoki Furusho, Fukuoka-shi (JP)

Correspondence Address: HEWLETT-PACKARD COMPANY;Intellectual Property Administration, P.O. Box 272400, Fort Collins, CO, 80527-2400, US

(21) Appl. No.: 10/840,221

(22) Filed: May 7, 2004

(30) Foreign Application Priority Data
May 7, 2003 (JP) P2003-129066

(51) Int. Cl. G06F 17/60

(52) U.S. Cl. 705/29

(57) ABSTRACT

A drawing of a system having plural components that are combined is formed based on components in a computer having a volatile memory and diagram data having drawings of the components. Information about the arrangement of the components on the drawing is received. Drawing information of the system is produced as a bitmap object by a processor of the computer, based on the received component arrangement information and the component diagram data. The volatile memory stores the bitmap object. The stored bitmap object is transmitted as an image.

### BACKGROUND OF THE INVENTION

1. Field of the Invention

The present invention is related to a drawing system and a drawing method. More specifically, the present invention is directed to a system and a method, capable of automatically executing drawing operations via a network.

2. Background Art

Household equipment/appliances, such as custom kitchens and sectional furniture, are designed by combining a plurality of structural components with each other. The components have been previously prepared in accordance with several variables, e.g. the dimensions of kitchens and rooms where these household equipment/appliances are installed, necessary functions of the household equipment/appliances, budgets thereof, and the like.

Conventionally, designing of household equipment/appliances has been carried out by experts who have designed in hand-writing styles, or who utilize computer-aided drawing techniques.

Also, systems for automatically forming drawings by using computers have been developed. For instance, a system has been developed in which a file having content requested by a requesting system of a business section is formed and transferred to a server that drives a CAD system for automatically forming a drawing in accordance with the file of the request content; see, for example, “[CONSTRUCTION OF AUTOMATIC DRAWING SYSTEM] using a fully automated CAD” written by Masahiro NORIDA of EIDAI SANGYO KK, [online], [retrieved on Mar. 14, 2003], Internet <URL: http://www.nua.or.jp/keywords/thesis/h11/11-nyu-283.HTML>

Very recently, there are Web sites on the Internet for designing and estimating custom, virtual kitchens. In some of these Web sites, virtual kitchens are drawn in response to information entered by users. However, the latter-mentioned Web sites take a relatively long time to perform these drawing operations, and/or merely select one or more of several previously drawn patterns that are displayed to shorten the time required for a drawing operation.

Furthermore, if the shape and/or color pattern of a specific component are changed due to a model change in a custom kitchen, drawings of all patterns related to the changed specific component must be redrawn, and/or programs for creating the virtual kitchen must be re-done.

Generally speaking, since these drawing operations are carried out by employing high-end servers equipped with high-speed processors, the time required for these drawing operations can be shortened. However, the present inventors have found that if conventional PC (personal computer) servers are employed, the PC servers can execute drawing operations at an acceptable higher speed by reducing the total number of file reading/writing operations with respect to storage apparatus.

Also, the present inventors have found that cost efficiency for developing a program is increased by separating program portions having data about components within a drawing program from other portions of the program. Separating the program portions in this way reduces program changes caused by changes in the component data, compared to program changes resulting from preliminarily providing several patterns of drawings.

### SUMMARY OF THE INVENTION

An object of the present invention is to provide a new and improved system and method for performing high speed computer drawing operations.

Another object of the present invention is to provide a new and improved computer controlled drawing system and a drawing method having a reduced server maintenance load.

A further object of the present invention is to provide a new and improved computer controlled system for and method of performing a drawing operation without forming an intermediate file.

A further object of the present invention is to provide a new and improved computer controlled system for and method of forming a perspective view at high speed, and providing a file of a drawing.

A further object of the present invention is to provide a new and improved computer controlled system for and method of executing a drawing operation in a dynamic timely manner in response to requests by a user.

A further object of the present invention is to provide new and improved general-purpose automatic drawing application software.

A further object of the present invention is to provide a new and improved method of readily developing automatic drawing application software in response to merchandise.

A further object of the present invention is to provide new and improved automatic drawing application software, to which changes in merchandise and components can be easily applied.

In accordance with one aspect of the present invention, a drawing system for forming a drawing of a system in which a plurality of components are combined, comprises a merchandise information provider terminal adapted to be responsive to (a) component arrangement information used to arrange the components on the drawing, (b) estimate information used to calculate prices of the components, and (c) a drawing-functional component diagram used to draw drawings of the components. A component arrangement information and estimate information database stores the component arrangement information and the estimate information, which are supplied to the data base by the merchandise information provider terminal. A component diagram database stores the drawing-functional component diagram entered via the merchandise information provider terminal. A database server transmits the component arrangement information and the estimate information which are stored in the component arrangement information and estimate information database. A Web and application server receives a request and a condition, which the Web and application server uses to form a drawing. The Web and application server receives component arrangement information corresponding to the received condition from the database server, and forms the drawing of the system in which the components have been combined, based on the received component arrangement information and the drawing-functional component diagram which has been stored in the component diagram database.

In accordance with another aspect of the present invention, a method of forming a drawing of a system in which a plurality of components are combined based on component diagram data having drawings of the respective components in a computer having a volatile memory and a processor, comprises receiving component arrangement information that specifies the arrangement of components on the drawing. The processor generates drawing information of the system as a bitmap object memory based on the received component arrangement information and the component diagram data. The bitmap object is stored by the volatile memory, and thence is transmitted.

Preferably the bitmap object is transmitted as stream data (hereinafter referred to as “transmitting by streaming” in this document).

The component arrangement information and the component diagram data are preferably independent of each other.

Also, the component arrangement information preferably includes coordinates of a component, the size and scale of a drawing, an image frame, and a dimensional line.

Further, the drawing information of the system is preferably formed as a drawing file.

Also, the drawing information of the system is a perspective view in one embodiment.

In accordance with a further aspect of the present invention, a computer having a volatile memory and a processor performs a method of forming a written estimate of the cost of a system in which a plurality of components are combined based on component diagram data having drawings of the respective components and price data having price information of the respective components. The method comprises receiving component arrangement information for arranging the components on a drawing. Drawing information about the system is generated by the processor as a bitmap object based on the received component arrangement information and the component diagram data. Estimate information about the system is generated based on the received component arrangement information and the price data. The bitmap object is stored in the volatile memory, and thence is transmitted with the estimate information of the system. The generated estimate information is preferably stored with an identification number that specifies the estimate information for thereby enabling the written estimate to be retrieved.

In accordance with a further aspect of the present invention, a computer having a volatile memory and a processor produces a drawing of a system in which a plurality of components are combined, based on component diagram data having drawings of the respective components. The processor forms the system drawing by: (1) receiving component arrangement information for arranging the components on a drawing; (2) generating drawing information of the system as a bitmap object, based on the received component arrangement information and the component drawing data. The bitmap object is stored in the volatile memory and transmitted from the volatile memory.

In accordance with a further aspect of the present invention, a computer having a processor and a volatile memory form a written estimate of a system in which a plurality of components are combined. The estimate has been formed based on component diagram data having drawings of the respective components and price data having price information of the respective components. The computer and processor form the written estimate by: (1) receiving component arrangement information for arranging the components on a drawing; (2) generating, by the processor, drawing information of the system as a bitmap object based on the received component arrangement information and the component drawing data; (3) generating estimate information of the system based on the received component arrangement information and the price data; and (4) storing the bitmap object in the volatile memory. The bitmap object stored in the volatile memory and the estimate information of the system are transmitted.

In accordance with a further aspect of the present invention, a computer program product for enabling a computer having a volatile memory and a processor to form a drawing of a system in which a plurality of components are combined based on component diagram data having drawings of the respective components causes the computer to: (1) receive component arrangement information for arranging the components on the drawing; (2) activate the processor to produce drawing information of the system as a bitmap object based on the received component arrangement information and the component drawing data; (3) store the bitmap objects in the volatile memory; and (4) transmit the bitmap object formed stored in the volatile memory.

In accordance with a further aspect of the present invention, a data structure of a computer having a volatile memory and a processor causes a display of the computer to display a written estimate of a system in which a plurality of components have been combined based on component diagram data having drawings of the respective components and price data having price information of the respective components. The data structure causes (1) drawing information of the system to be generated as a bitmap object based on information about the arrangement of the components on the drawing and the component diagram data; and (2) cost estimate information of the system to be generated based on the component arrangement information and the price data.

### BRIEF DESCRIPTION OF THE DRAWINGS

FIG. 1 is a schematic diagram of an automatic drawing system according to a preferred embodiment of the present invention.

FIG. 2 is a block diagram of the configuration of a Web and application server in the system of FIG. 1.

FIG. 3 is a data flow diagram of operations of the automatic drawing system of FIG. 1.

FIG. 4 is a detailed data flow diagram of the drawing portions of the automatic drawing system of FIG. 1.

FIG. 5 is a diagram representing both the structure and operation of application software 144 of FIG. 1.

FIG. 6 is a drawing of an exemplary color display (shown in monochrome) including a perspective view of a preferred embodiment of the virtual kitchen which has been processed by one preferred embodiment of FIG. 1.

FIG. 7 is a drawing of a display of an exemplary perspective view which has been processed in a shadowing line, according to a preferred embodiment of FIG. 1.

FIG. 8 is a drawing of a display of an exemplary perspective view which has been processed in a wire frame, according to a preferred embodiment of FIG. 1.

### DETAILED DESCRIPTION OF THE DRAWING

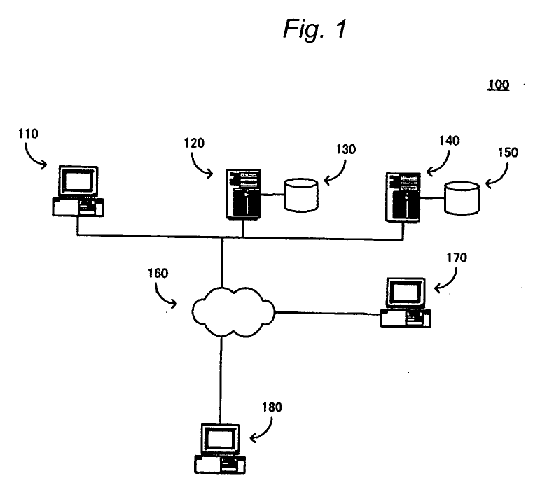

FIG. 1 is a block diagram of an automatic drawing system 100 containing a merchandise information provider terminal 110, a database server 120, a component arrangement information and estimate information database 130 which is connected to the data server 120, a Web and application server 140, a component diagram database 150 which is connected to the Web and application server 140. Terminal 110 and server 120, as well as server 140, are connected to a network 160, in turn connected to a business terminal 170 and a consumer terminal 180.

The merchandise information provider terminal 110 is used to input a drawing-functional component diagram, such as a custom kitchen, corresponding to a drawn subject, a drawing instruction corresponding to information used to arrange a component, and price data originating from a provider of merchandise information. The merchandise information provider terminal 110 causes (1) the drawing instruction and the price data to be stored in the component arrangement information and estimate information database 130, via the database server 120, and (2) the drawing-functional component diagram to be stored in the component diagram database 150, via the Web and application server 140. The database server 120 contains operating software (for example, Windows 2000 Server of Microsoft Corporation, NET Framework) and database software (for instance, Oracle 9i of Oracle Corporation).

The component arrangement information and estimate information database 130 is controlled by the database software of the database server 120. The component arrangement information and estimate information database 130 stores the drawing instruction and the price data, which are provided by the merchandise information provider terminal 110.

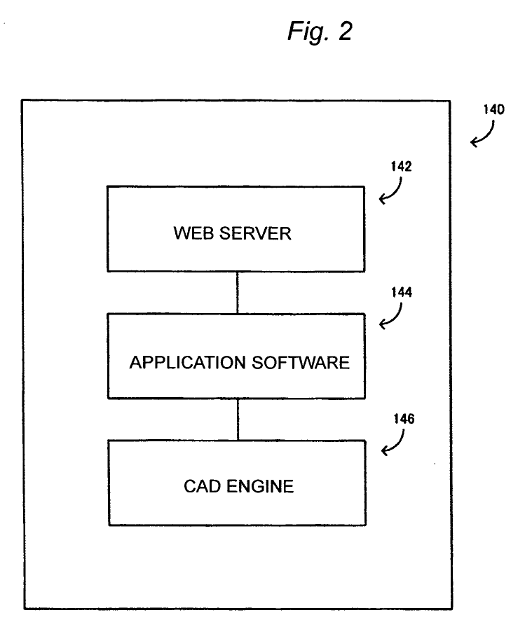

As shown in FIG. 2, the Web and application server 140 contains a Web server 142, application software 144, and a CAD (computer-aided design) engine 146. The Web server 142 provides a Web page used for a custom kitchen drawing operation, and a management tool of Web pages. Also, the Web and application server 140 has a volatile memory (not shown), such as a random access memory (RAM), and a processor (not shown).

Web server 142 includes, for instance, an Internet information server (IIS) of Microsoft Corporation. The application software 144 causes the CAD engine 146 to perform a drawing operation in response to a request issued to the Web server 142 by either the business terminal 170 or the consumer terminal 180. CAD engine 146 supplies the electronic drawing it made to Web server 142 that in turn supplies the electronic drawing to either the business terminal 170 or the consumer terminal 180, respectively. CAD engine 146 is controlled by the application software 144, and executes a drawing operation by using the component arrangement information stored in the component arrangement information and estimate information database 130, and the drawing-functional component drawing stored in the component drawing database 150. After CAD engine 146 makes the drawing, the CAD engine transfers the drawing to the application software 144. Preferably, the CAD engine 146 can perform a plurality of operations at the same time in a server. “Gbase” of System Soken can be employed as CAD engine 146.

Referring back to FIG. 1, the component diagram database 150 stores a drawing-functional component diagram which is provided by the merchandise information provider terminal 110.

The merchandise information provider terminal 110, the database server 120, and the Web and application server 140 are connected to the network 160.

Alternatively, the merchandise information provider terminal 110, the database server 120, and the Web and application server 140 are connected to an enterprise built-in network (not shown) which is independently provided from the network 160, in turn connected to the network 160.

The network 160 may be the Internet, or a local area network (LAN), or a wide area network (WAN).

The business terminal 170 responds to requests for a drawing operation of a custom kitchen by a business staff member. The business terminal 170 can be, for example, a personal computer (PC) having a Web browser. The business terminal 170 has access rights with respect to the Web and application server 140, which differs from the access rights of the consumer terminal 180, as described infra.

The consumer terminal 180 responds to requests for a drawing operation by a consumer who is considering a purchase of a custom kitchen. The consumer terminal 180 can be, for example, a personal computer (PC) on which a Web browser has been installed.

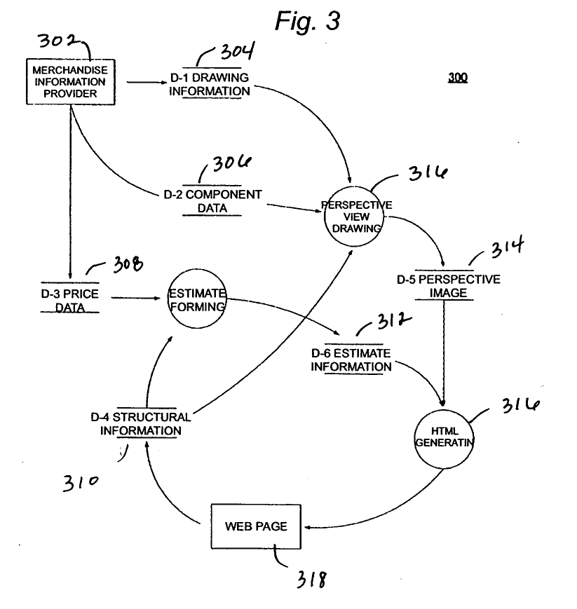

FIG. 3 is a data flow diagram 300 of the automatic drawing system according to the present invention. Also, Table 1 and Table 2 respectively include descriptions of external entity and data store, which are employed in the data flow diagram 300.

TABLE 1
External Entity

| ID | Entity name | Description |
|---|---|---|
| 1 | Merchandise | Department for managing merchandise to be |
| | information provider | drawn. Providing component data and arrange- |
| | | ment information of merchandise. |
| 2 | Web page | Web page used to input structure of mer- |
| | | chandise (e.g. custom kitchen), and display |
| | | estimate and drawing results. |
| 3 | User | General consumer who has idea to purchase |
| | | merchandise (e.g. custom kitchen). |

TABLE 2
Data Store

| No. | Title | Contents of data |
|---|---|---|
| D-1 | Drawing information | Drawing instruction for drawing engine |
| | | instructed by merchandise information |
| | | provider (arrangement of components, |
| | | drawing of dimension lines, arrangement |
| | | of image frames etc.). |
| D-2 | Component data | Component data used to form general- |
| | | purpose drawing. Component data are |
| | | prepared as three-dimensional cad file. |
| D-3 | Price data | Price information used to form estimate. |
| D-4 | Structural | Information for combining merchandise |
| | information | entered/selected from web page. |
| D-5 | Perspective image | Drawn perspective view (existing not as |
| | | file, but object on memory). |
| D-6 | Estimate information | Estimate information such as price and the |
| | | like as to combined results |
| | | of merchandise. |

An automatic drawing method for an exemplary custom kitchen is now described in connection with FIGS. 1-3, Table 1, and Table 2.

Input of Information and Condition:

During operation 302 (that occurs before the remaining steps of FIG. 3), a merchandise information provider inputs to the system of FIG. 1 the information required for a drawing operation and an estimating operation by using the merchandise information provider terminal 110. The information corresponds to drawing information 304, component data 306, price data 308, and the like. Terminal 110 supplies the entered drawing information 304 and the entered price data 308 to server 120 that causes information 304 and data 308 to be stored in the component arrangement information and estimate information database 130. Terminal 110 supplies the entered component data 130 to server 140 that causes the component data to be stored in the component drawing database 150.

Next, a general consumer (user) who is considering the purchase of a custom kitchen enters, at consumer terminal 180, structural information 310 for the custom kitchen to a Web page. The user selects the desirable items from previously prepared selection items on the Web page; namely, the user selects the shapes (for example, I-shape, L-shape) of the custom kitchen, dimensions of walls, presence/absence of dish washing/drying machines, types of cooking appliances, presence/absence of storage drawers, cabinets and pantries, types of cooking ranges, color patterns of kitchen counters, color patterns of kitchen doors, and the like.

Operations to Form Drawing:

In response to the structural information 310 being completely entered by the user and transmitted via network 160 to servers 120 and 140, server 140 begins to make a drawing. The application software 144 of server 140 selects the necessary components in response to the structural information 310 (D-4) entered by the user at the consumer terminal 180, and reads the drawing information 304 (D-1). Server 120 responds to the component data 306(D-2) for the selected components, as read from the estimate information database 130 and the component drawing database 150. Server 120 then transfers the above-described information to the CAD engine 146. The CAD engine 146 draws a perspective view based on the structural information 310 (D-4), the drawing information 304 (D-1), and the component data 306 (D-2). The perspective view which has been drawn by the CAD engine 146 is not stored as a file, but an image of this perspective view is outputted as an object on the memory.

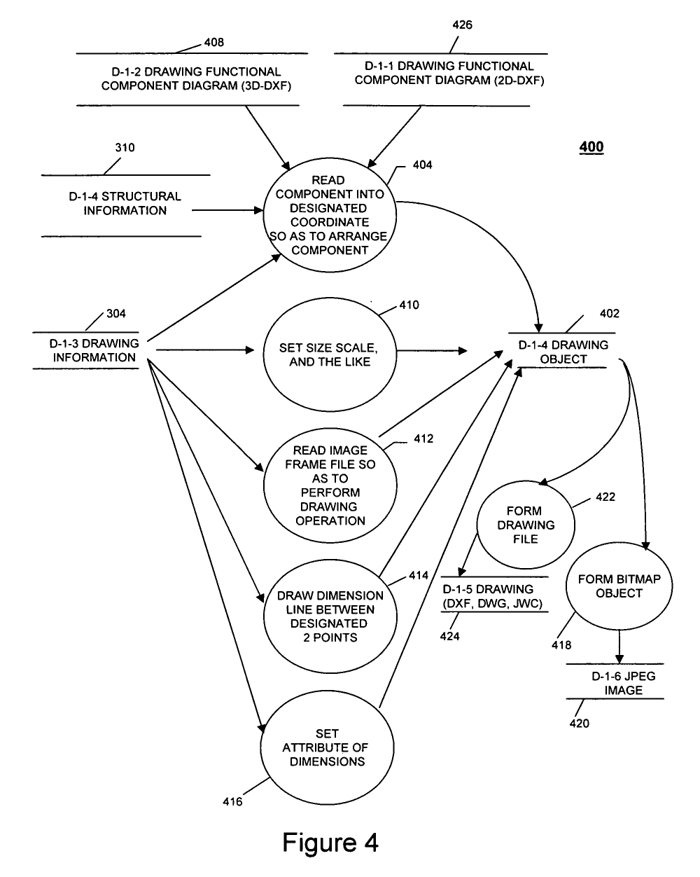

FIG. 4 is a detailed data flow diagram 400 of the drawing operation portion in the automatic drawing system included in FIGS. 1-3. The CAD engine 146 produces a drawing object 402 (D-1-4) that is stored in a memory 150. Engine 146 draws the object in response to the structural information 310 (D-1-4), the drawing information 304 (D-1-3), and a three dimensional drawing-functional component diagram 408 (3D-DXF)(D-1-2) which corresponds to three-dimensional component data used to form the perspective drawing. CAD engine 146 first reads components out from the structural information 310 (D-1-4), the drawing information 304 (D-1-3), and the drawing-functional component diagram 408 (3D-DXF)(D-1-2), and then arranges the read components in a designated coordinate system (step 404). The data may be alternatively prepared as patterns, or the data may be alternatively inputted by the user.

Next, the CAD engine 146 executes various operations, for instance, engine 146 sets sizes, reduction scales, and the like (step 410) with respect to the arranged components by employing the drawing information 304 (D-1-3). The CAD engine 146 draws the image by reading an image frame file (step 412). The CAD engine 146 draws a dimension line between two designated points (step 414), and sets an attribute of the dimension line (step 416). Further, the CAD engine 146 forms a bitmap object (step 418) and thus obtains a JPEG (Joint Photograph Experts Group) image 420 (D-1-6) that is supplied to a Web page described infra.

If a formed drawing is to be outputted as a file, the CAD engine 146 forms a drawing file (step 422), and then, obtains DXF (Drawing Interchange Format), DWG, JWC file type drawings 424 (D-1-5). If a general-purpose diagram, rather than a perspective drawing is to be formed, instead of the drawing-purpose component diagram 408 (3D-DXF)(D-1-2), a drawing-purpose component diagram 426 (2D-DXF)(D-1-1) is employed. In such a case, diagram 426 corresponds to two-dimensional component data used to form the general-purpose diagram.

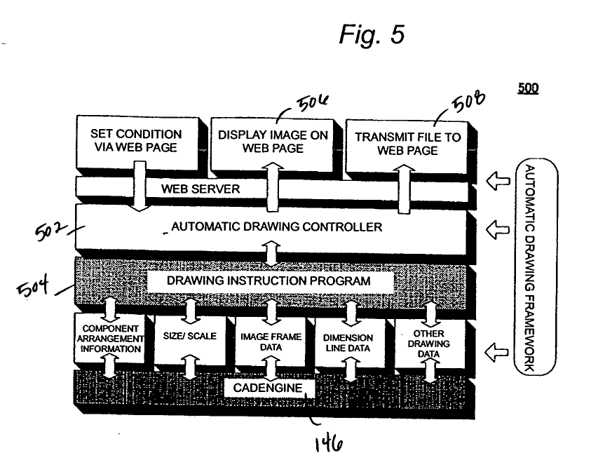

The structure and operations of the application software 144 are now described in connection with FIG. 5. The application software 144, as illustrated in FIG. 5, contains an automatic drawing controller 502 and a drawing instruction program 504. The automatic drawing controller 502 accepts conditions set by the user via the Web page, and then retrieves the drawing instruction program 504. The drawing instruction program 504 sets values in controller 504 for respective drawing data classes, calls a drawing method, and thus, causes CAD engine 146 to perform a drawing operation. After the CAD engine 146 has accomplished the drawing operations, the automatic drawing controller 502 executes a process operation that optimizes the drawn image so as to display the optimized drawn image on the Web (step 506), and then returns this optimized drawn image as stream data to the Web page (step 508). The optimizing process operation includes an enlarging operation, a compressing operation, a line segment interpolating operation (antialiasing), and the like. If the optimized drawn image is returned as a file, the automatic forming controller 502 forms such formatted files as a PDF file, a TIFF (Tagged Image File Format) file, and a DXF file from the drawn drawing, and then returns this formed file to the Web page.

In FIG. 5, drawing instruction programs which are different from each other in accordance with characteristics of merchandise are arranged as programs which are independently provided by the automatic forming controller, so that a general-purpose automatic drawing application can be alternatively constituted. The automatic drawing application contains a data class definition for a drawing operation, a property and a method for a drawing operation, a CAD engine, and an interface with respect to a Web server.

Forming of Estimate:

Returning back to FIG. 3, when a structural condition is entered by the user, preparation of a cost estimate is commenced in conjunction with the operation of forming a drawing. The application software 144 selects the necessary components based on the structural information 310 (D-4) which is entered from the consumer terminal 180, reads out price data 308 (D-3) of the selected components from the estimate information database 130, and calculates the price of the entire custom kitchen in such a manner that the prices of the selected components are summarized, so that this application software 144 prepares cost estimate information. The cost estimate information may contain information as to the price of only the entire custom kitchen, or the itemized prices of the respective structural components.

Output to Web Page:

The application software 144 forms the web page having the written estimate including the estimate information 312 (D-6) calculated for the image 314 (D-5) of the perspective view drawn by the CAD engine 146 and the application software 144 with HTML (Hyper Text Markup Language) (operation 316) or XML (extensible Markup Language). In this case, the Web server 142 directly transmits, as a web page (operation 318), the image 314 (D-5) of the perspective view from the memory to the Web browser of the consumer terminal 180 by streaming. If the drawing operation 316 of the perspective view need not be executed at high speed and the perspective view is sought to be stored in the user, an image of the perspective view can be alternatively transmitted in the form of either a JPEG file or a DXF file. Alternatively, when an entire written estimate is desired to be transmitted in such a manner that the entire written estimate can be stored, the entire written estimate is converted into a PDF (Portable Document Format) file type which is transmitted. If the entire written estimate is supplied to a facsimile machine, the entire written estimate is alternatively converted to a TIFF file type which is transmitted. It is desirable that the written estimate be stored in combination with a unique identification number that specifies relevant written estimates, and is called by the business terminal 170 (see FIG. 1). In this case, in view of security, it is desirable for a user's coded access to business terminal 170 to differ from the user's coded access to consumer terminal 180 in such a manner that a written estimate of a third party can be accessed from the business terminal, whereas the written estimate of the third party cannot be accessed from the consumer terminal.

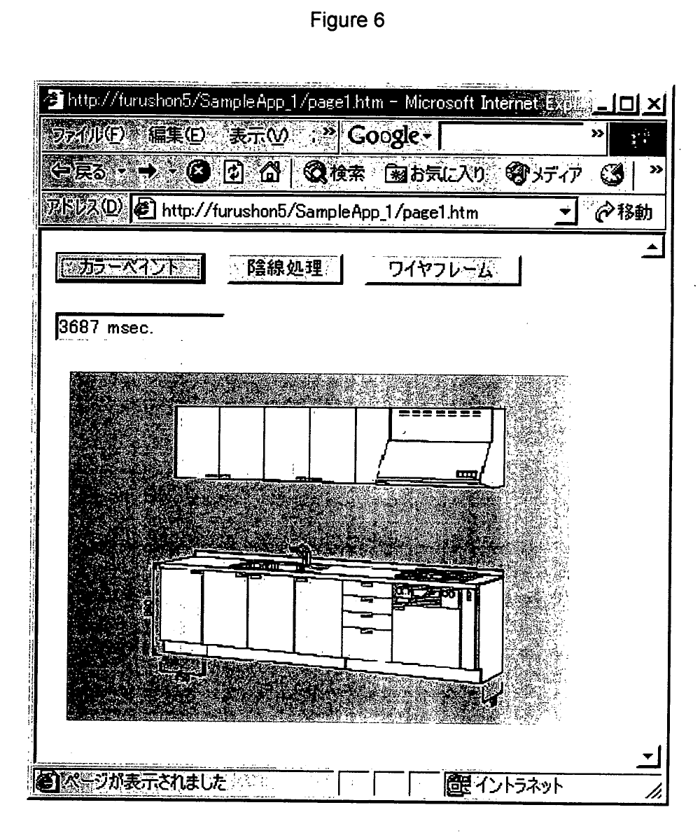

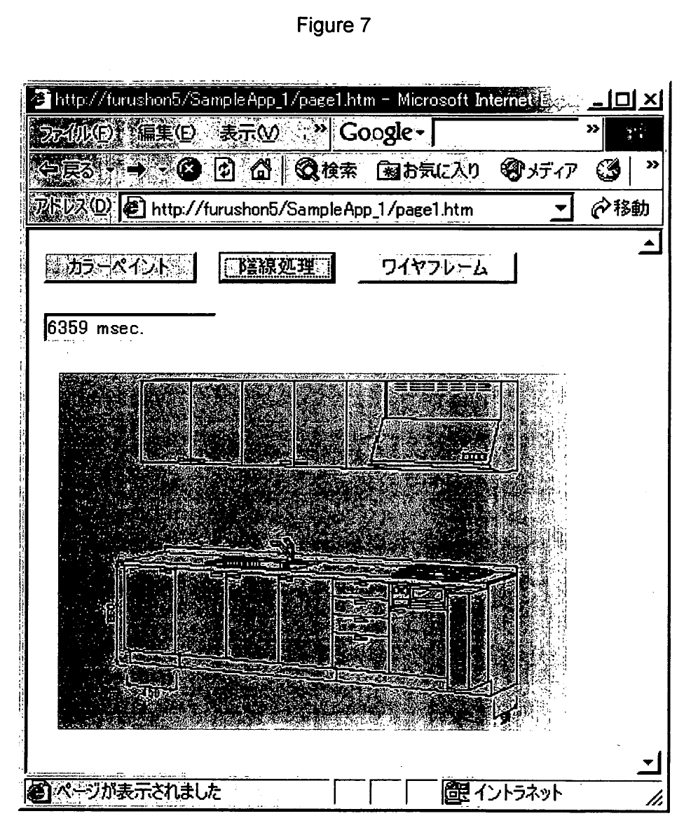

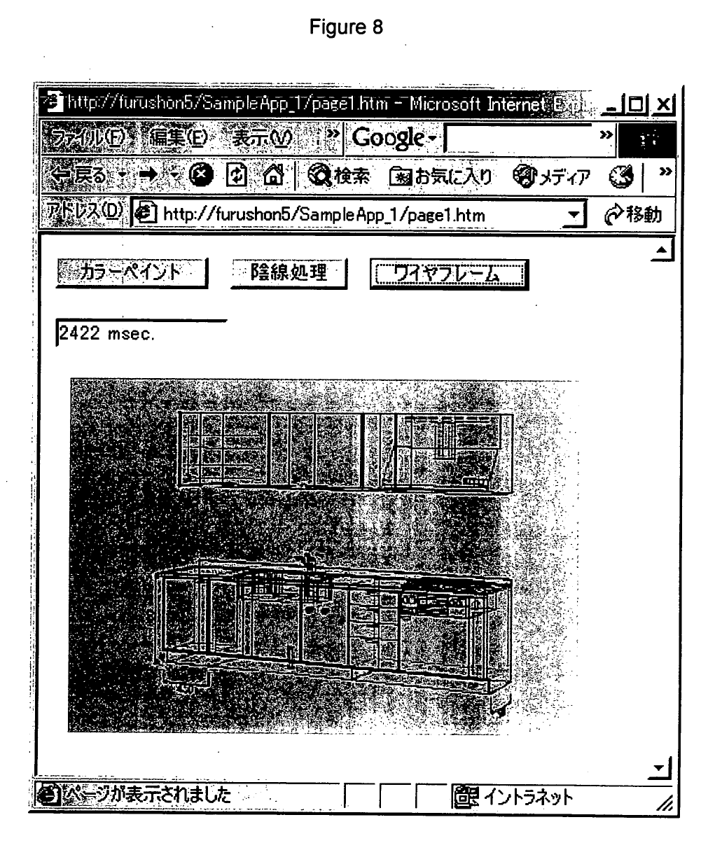

FIGS. 6-8 are examples of outputs to the Web page. FIG. 6 includes an exemplary display of a colored perspective view (the perspective view is shown in monochrome in FIG. 6), and indicates that a time duration of 3687 ms was required for the drawing operation. FIG. 7 is an exemplary display of a perspective view which has been processed by a shadowing line, and indicates that a time duration of 6359 ms was required for the drawing operation. FIG. 8 is an exemplary display of a perspective view which has been processed by a wire frame, and indicates that a time duration of 2422 ms was required for the drawing operation.

It should also be noted that the operations of FIGS. 3-5 can be realized by employing hardware, or software, or by combining hardware and software with each other. Also, the present invention can be alternatively assembled into a computer program product capable of executing these methods on a computer system. The expression “computer program product” means a recording medium on which the computer program has been recorded, a storage system storing the computer program, a computer system into which the computer program has been read, an Internet system into which the computer program has been read, and a product which utilizes the computer program.

### EFFECTS OF THE INVENTION

The system and the method can perform the drawing operation at high speed.

The system and the method can perform the drawing operation without forming an intermediate file.

The system and the method can form the perspective view at high speed, and provide the file of the drawing.

The system and the method can execute the drawing operation in a dynamic real time manner in response to requests issued by the user.

General-purpose automatic drawing application software can be provided.

The method is capable of readily developing the automatic drawing application software in response to the merchandise.

The automatic drawing application software can be provided so the changes in the merchandise and the components can be easily applied.

1. A system for forming a drawing of a system having a plurality of components that are to be combined comprising:
a merchandise information provider terminal adapted to be responsive to component arrangement information used to arrange the components on the drawing, estimate information used to calculate prices of the components, and a drawing-functional component diagram used to draw drawings of the components;
a component arrangement information and estimate information database for storing the component arrangement information and the estimate information adapted to be entered at said merchandise information provider terminal;
a component diagram database for storing the drawing-functional component diagram entered at said merchandise information provider terminal;
a database server for transmitting the component arrangement information and the estimate information stored in said component arrangement information and estimate information database; and
a Web and application server for receiving a request and a condition, which are used to form a drawing, and for forming the drawing;
said Web and application server being arranged to: (a) receive component arrangement information corresponding to the received condition from said database server, and (b) form the drawing of the system in which the components are to be combined based on said received component arrangement information and the drawing-purpose component diagram stored in said component diagram database.

2. A method of forming a drawing of a system in which a plurality of components are combined based on component diagram data having drawings of the respective components, the method being performed with a computer having a volatile memory and a processor, the method comprising:
receiving component arrangement information including an arrangement of the components on the drawing;
generating, by using the processor, drawing information of the system as a bitmap object based on the received component arrangement information and the component diagram data; and
storing the bitmap object in the volatile memory.

3. The method of claim 2 further including transmitting the bitmap object stored in the volatile memory.

4. A method of forming a drawing of a system as claimed in claim 3 wherein:
said step of transmitting said bitmap object includes transmitting said bitmap object by streaming.

5. A method of forming a drawing of a system as claimed in claim 2 wherein:
said component arrangement information and said component diagram data are independent of each other.

6. A method of forming a drawing of a system as claimed in claim 2 wherein:
said component arrangement information includes the coordinates of a component, the size of the drawing, the scale of the drawing, an image frame, and a dimensional line.

7. A method of forming a drawing of a system as claimed in claim 2 further comprising:
forming drawing information of the system as a drawing file.

8. A method of forming a drawing of a system as claimed in claim 2 wherein:
the drawing information of said system is a perspective view.

9. A method of forming a written estimate of a system in which a plurality of components are combined based on component diagram data having drawings of the respective components and price data having price information of the respective components, the method being performed with in a computer having a volatile memory and a processor, comprising:
receiving component arrangement information including an arrangement of the components on a drawing;
generating, by using the processor, drawing information of the system as a bitmap object based on the received component arrangement information and the component diagram data;
storing the bit map object in the volatile memory; and
generating, by using the processor, estimate information of the system based on said received component arrangement information and said price data.

10. The method according to claim 9 further including
transmitting the bitmap object stored in said volatile memory; and
transmitting the estimate information of said system.

11. A method of forming a written estimate of a system as claimed in claim 9 further comprising:
storing the generated estimate information and an identification number that specifies said estimate information, whereby the written estimate can be retrieved.

12. A drawing of a system in which a plurality of components are combined, the drawing having been formed in a computer having a volatile memory and a processor based on component diagram data having drawings of the respective components;
said system drawing being formed by:
receiving component arrangement information including an arrangement of the components on a drawing;
generating, by the processor, drawing information of the system as a bitmap object based on the received component arrangement information and the component drawing data;
storing the bitmap object in the volatile memory; and
transmitting the bitmap object stored by the volatile memory.

13. A written estimate of a system in which a plurality of components are combined with each other, the system being formed in a computer having a volatile memory and a processor based on component diagram data having drawings of the respective components and price data having price information of the respective components;
said written estimate being formed by:
receiving component arrangement information including an arrangement of the components on a drawing;
generating, by using the processor, drawing information of the system as a bitmap object based on the received component arrangement information and the component drawing data;
storing the bit map object;
generating, by using the processor, estimate information of the system based on said received component arrangement information and said price data;
transmitting the bitmap object stored in the volatile memory; and
transmitting the estimate information of said system.

14. A computer program product for enabling a computer having a volatile memory and a processor to form a drawing of a system in which a plurality of components are combined with each other based on component diagram data having drawings of the respective components, the computer program product causing the computer to execute the steps of:
receiving component arrangement information including an arrangement of the components on the drawing;
producing, by the processor, drawing information of the system as a bitmap object based on the received component arrangement information and the component drawing data; and
storing the bit map object in the volatile memory.

15. The method according to claim 14 wherein the product causes the computer to perform the step of
transmitting the bitmap object stored by said volatile memory.

16. A data structure used to display, on a terminal apparatus, a written estimate of a system in which a plurality of components are combined based on (a) component diagram data having drawings of the respective components and (b) price data having price information of the respective components, the data structure being in a computer and comprising:
drawing information of the system which has been generated as a bitmap object based on component arrangement information for the arrangement of the components on the drawing and the component diagram data; and
cost estimate information of the system which has been generated based on said component arrangement information and said price data.

17. A data structure used to display, on a terminal apparatus, a written estimate of a system in which a plurality of components are combined based on (a) component diagram data having drawings of the respective components and (b) price data having price information of the respective components, the data structure being in a computer and comprising:
drawing information of the system including a bitmap object including component arrangement information for the arrangement of the components on the drawing and the component diagram data; and
cost estimate information of the system including costs of said component arrangement and said price data.
